(19) United States
(12) Patent Application Publication
(10) Pub. No.: US 2012/0068076 A1
(43) Pub. Date: Mar. 22, 2012

(54) PORTABLE PET SCANNER FOR IMAGING OF A PORTION OF THE BODY

(76) Inventor: Farhad Daghighian, Santa Monica, CA (US)

(21) Appl. No.: 13/023,475

(22) Filed: Feb. 8, 2011

Related U.S. Application Data
(63) Continuation-in-part of application No. 12/776,777, filed on May 10, 2010, now Pat. No. 8,050,743.
Application No. 12/776,777 is a division of application No. 11/929,349, filed on Oct. 30, 2007, now Pat. No. 7,750,311.
(60) Provisional application No. 61/302,452, filed on Feb. 8, 2010.

(51) Int. Cl. G01T 1/164

(52) U.S. Cl. 250/363.03

(57) ABSTRACT

A mobile PET scanner for use in bed side or a surgical environment comprises a mobile support base, with first and a second arm arms extending therefrom. The first arm is configured for placement under a table supporting an individual while the second arm is substantially parallel to and above said first arm with the individual being located between the first and second arms. Multiple module blocks are positioned along the length of the first and second arm. Each modules block comprises scintillators with solid state silicone multipliers or multi-pixel photon counters attached thereto. Positrons emitted from radiation labeled tissue within the individual's body impinge on the multiple scintillators to generate. The photons from each of the scintillator are received by each of a solid state silicone multipliers or multi-pixel photon counters associated therewith and an electrical signal representative of the received photons is then generated. The electrical signal output from each of the solid state silicone multipliers or multi-pixel photon counters is then transmitted to a computerized data collection and analysis system, which substantially instantaneously generates a visual image on a screen showing the location within the individuals body emitted the photons. This image can be coordinated with a photo image or a CT image showing the same portion of the individual's body.

This application claims benefit of Provisional Application 61/302,452 and is a Continuation-In-Part of U.S. application Ser. No. 12/776,777, filed May 10, 2010, which is a Divisional of application Ser. No. 11/929,349, filed Oct. 30, 2007, now U.S. Pat. No. 7,750,311.

The devices described herein include novel detector modules for positron emission tomography (PET) that utilizes a novel photodetector referred to as solid state photomultiplier. (SSPM). These SSPM enable development of novel detector configurations for PET scanners that are more compact and therefore portable. Also, the fast response times of solid state photomultipliers enable time-of-flight assisted limited-angle tomography, and therefore imaging of only that part of the body that is of interest.

### BACKGROUND

Positron emission tomography (PET) is becoming a powerful modality to image cancer and other disease. It is the most accurate non-invasive method for measuring the concentrations of radiolabeled tracers in different locations of the body. PET is capable of imaging and measuring the concentrations of a particular biochemical, which in turn provides important physiological parameters in specific locations or organs. PET is an imaging modality that provides biochemical and physiologic information, whereas CT scans or MRI provides anatomical or structural information (Daghighian F, Sumida R, and Phelps M E.: “PET Imaging: An Overview and Instrumentation” J. Nucl. Med. Tech. 18. 5 (1990)). Most of the basic elements of biological materials have positron-emitting isotopes (e.g., C-11, N-13, O-15, F-18, I-124). More than 1000 biochemicals have been labeled with these isotopes (e.g., amino acids, fatty acids, sugars, antibodies, drugs, neuroreceptor ligands, nucleoside analogues, etc).

The basic principle behind PET is that positrons emitted by positron emitting isotopes find an electron that annihilates to two identical photons that travel in opposite directions (FIG. 1). The patient is injected with a positron emitting radio-pharmaceutical, such as F-18 labeled flourodeoxyglucose. This radio-pharmaceutical accumulates in the cancer tissues in amounts greater than other tissues. The patient is surrounded by a ring of detectors that are tuned to detect the annihilation photons of the positron-electron annihilation that occurs in the regions where the radio-pharmaceutical is concentrated. Therefore the positron emission is detected based on the detection of two annihilation photons by gamma ray detectors of the PET scanner. The computer portion of the PET scanner records the location of the two detectors that were hit by such photons within a time window of a few nanoseconds (coincidence time window). This coincidence detection of the annihilation photons is an essential part of the positron emission tomography. The position of the positron source is on the line that connects these two detectors, called the “line of response”. The collection of these lines of response, from all angles, allows tomographic reconstruction of the distribution of the radio-pharmaceuticals in the body of the patient, forming the PET images.

The preferred basic element of the novel detector module for the PET scanners disclosed herein is a photo-detector referred to as a Solid-State Photomultiplier (SSPM), or Silicon Photomultipliers (SiPM). Introduced in 2002, SSPMs have so far been used mainly in high energy and astrophysics experiments where very high sensitivity light detection is required. Such a device is a large assembly of micro pixel diodes operating in a binary mode. Each detector consists of an array of approximately 600 micropixels connected in parallel. The micropixels act individually as binary photon detectors, in that an interaction with a single photon causes a discharge. Each micropixel “switch” operates independently of the others, and the detector signal is the summed output of all micropixels within a given integration time. When coupled to a scintillator, the SSPM detects the light produced in the scintillator by incident radiation, giving rise to a signal proportional to the energy of the radiation. SSPMs have many advantages over photomultiplier tubes (the current standard for scintillation-based detection of radiation). An important advantage is that the operating voltage for SSPMs is around 30-90 V, as opposed to the kilovoltages required for PMTs, yielding a clear safety advantage for devices to be used inside the body. SSPMs are also extremely small—a 1×1 mm² detector performs comparably to a PMT with a 1 cm diameter and 5 cm length. SSPMs have an extremely fast signal rise time (˜140 ps), high gain (˜10⁶), good quantum efficiency at 420 nm (40%), high stability, and low dark current at room temperature. Buzhan P, et al. Nuc. Inst. Meth. Phys Res A, 504, p 48-52 (2003). SSPM's were recently introduced to the market and are being used in high-energy physics experiments at CERN, SLAC, and DESY (V. Saveliev, “The recent development and study of silicon photomultiplier,” Nuclear Instruments & Methods in Physics Research Section a-Accelerators Spectrometers Detectors and Associated Equipment, vol. 535, pp. 528-532, 2004.)

### DISCUSSION OF THE STATE OF THE ART

Depth Of Interaction” Problem—The uncertainty of the annihilation photon's interaction point in a scintillation crystal is known as the Depth-of-Interaction (DOI) problem. This effect degrades spatial resolution since an uncertainty in the interaction location results in an error in the identification of the proper line-of-response (LOR) for that event. This blurring effect increases with the radial offset of the source position in the FOV. To reduce this problem, the current PET scanners are built with a detector ring diameter 35-50% larger than the diameter of the patient port. Since only the central portion of the FOV is used and that portion suffers less radial blurring, the extent of this effect can be reduced. This remedy has two major disadvantages:
1) An increased number of scintillators and PMTs with associated electronics results in a higher cost, and
2) A reduction in sensitivity, which is directly proportional to the system diameter, requires longer scan duration and/or produces increased image noise.
   Shortening the depth of each detector element can also reduce the DOI effect; however, this will also reduce the system sensitivity. Disclosed herein is a new and unique detector module that can determine with a high degree of accuracy the DOI of the photons in the detector and thus increase the sensitivity of the disclosed system. The information obtained from this new detector can be used to assign the event to the proper line of response.

In the last few years, important developments have been made in building PET scanners with high spatial resolution. In general, despite the improvement in spatial resolution, the sensitivity of scanners has not improved. There are two reasons for this: 1) Typically the detector ring is substantially larger than the port to reduce the effect of the “Depth of Interaction problem”, 2) The use of narrow and shallow detectors to reduce the depth of interaction problem typically results in a loss of sensitivity due to a significant amount of inter-detector scatter that is rejected by the detector electronics.

Utilizing the Monte-Carlo simulation package Geant4, Moehrs et al. studied a detector module for a small-animal PET imaging system with intrinsic DOI information. (S Moehrs, A Del Guerra, D J Herbert, M A Mandelkern A detector head design for small-animal PET with silicon photomultipliers (SiPM) Phys. Med. Biol. 51 (2006) 1113-1127). Instead of a pixelated scintillator, this design is based upon the classic Anger camera principle, i.e. the head is constructed of modular layers, each consisting of a continuous slab of scintillator, a thin light guide, and an array of SSPM (1 mm² sensitive area and a pitch of 1.5 mm). A detector head of about 4×4 cm² was simulated; it was constructed from three modular layers of the type described above. The thickness of the scintillator slab and the light guide were varied between 3 to 6 mm, and 0.1 to 1 mm, respectively. The results of the simulations revealed that:
a) The thickness of the light guide has minimal effect,
b) The backscattering is less than 5%,
c) The detector module has a nearly uniform efficiency for 511 keV photons of ˜70%, and
d) The best spatial resolution of 0.3 mm FWHM was observed for the 3 mm thick scintillator slab and no light guide, and 0.6 mm FWHM was observed for 6 mm thick slab and 1 mm light guide. This spatial resolution degraded to 1.5 mm close to the edges.
e) The position accuracy or the displacement error for a 5 mm thick slab was minimal between −15 and +15 mm from the center of the slab, but degraded to 1.5 mm at −19 and +19 mm from the center.
f) For a small-animal scanner, four of the above detector modules were simulated, facing each other on a square and rotating around a rodent with a diameter of 4 cm. The depth-of-interaction error was worst for layer-1 (closer to the animal) to layer-1 coincidences with a slab thickness of 8 mm, resulting in a maximum error of 1.4 mm. This PET configuration was 4 cm in diameter and thus limited to the use for small animals.

A high performance detector head with matrices of silicon photomultipliers (SiPMs) is under development at the University of Pisa. The Pisa group presented the preliminary results of their detector module at the IEEE NSS October 2007. The detector head is intended to be employed in the construction of a high spatial resolution, MR compatible, small animal PET scanner. Silicon photomultipliers from FBKirst (Trento, Italy) are being evaluated for this purpose. SiPM elements of 1×1 mm size and SiPM matrices composed of four (2×2) pixel elements were tested. The results with LSO crystals show an energy resolution of 20% FWHM at 511 keV, and a coincidence timing resolution of 600 ps rms. These devices are claimed to have improved characteristics and active area, as well as SiPM matrices with 16 pixels (4×4).

Researchers in the Netherlands and in Belgium have recently been investigating the use of 20×10×20 mm LYSO Slab for the design of a PET scanner with internal DOI correction using Avalanch Photo Diodes (APD) and more recently SSPM (S Moehrs, A Del Guerra, D J Herbert, M A Mandelkern A detector head design for small-animal PET with silicon photomultipliers (SiPM) Phys. Med. Biol. 51 (2006) 1113-1127; Y. Shao, S. R. Cherry, K. Farahani, et al., “Development of a PET detector system compatible with MRI/NMR systems,” IEEE Transactions on Nuclear Science, vol. 44, pp. 1167-1171, 1997; A. N. Otte, J. Banal, B. Dolgoshein, J. Hose, S. Klemin, E. Lorenz, R. Mirzoyan, E. Popova, and M. Teshima, “A test of silicon photomultipliers as readout for PET,” Nuclear Instruments & Methods in Physics Research Section a-Accelerators Spectrometers Detectors and Associated Equipment, vol., pp. 705-715, 2005.) They conducted a Monte Carlo simulation and took energy and timing measurement which successfully demonstrated this detector approach. Using 1.6×1.6 mm active APD spaced by 2.3 mm, they obtained a spatial resolution of 1.1 mm FWHM, an energy resolution of 11.5% FWHM, and 1.6 ns FWHM timing resolution. Their results demonstrated that a sensitivity of 8 cps/Bq can be obtained. SSPM is preferred to APD. For example, position-sensitive avalanche photodiodes (PS-APDs) operate at a high bias voltage, and yield a mediocre gain of only ˜10³.

Time-of-Flight (TOF) Information—Photons travel 30 cm per nanosecond. With the advent of faster photo detectors and scintillators, it has become possible to estimate the position of positron annihilation by measuring the difference in the time of arrival of the two annihilation photons into the detectors. Recently, Spanoudaki (Pratx, G. Chinn, G. Olcott, P. D. Levin, C. S., Fast, Accurate and Shift-Varying Line Projections for Iterative Reconstruction Using the GPU, IEEE Trans Med Imaging. 2009 March; 28(3):435-45) evaluated SiPMs (Hamamatsu MPPC 3 mm×3 mm) coupled to LYSO (3 mm×3 mm×10 mm). At SNM09, she reported a first-photon timing of 280 ps (an improvement from the value reported in her abstract). Time difference between the arrivals of the two annihilation photons (Δt) will limit the position of the positron annihilation to a line segment around the midpoint of the line-of-response. The length of this segment is equal to twice the speed of light (c) multiplied by Δt. (See FIG. 1)

To date, the time resolution of PET detectors is more than 0.3 nanosecond (FWHM), or 4.5 cm travel from the center of the decay; therefore, this information lacks sufficient resolution to locate the distribution of radioactivity using time of flight. However, this TOF information can help improve tomographic image reconstruction from the collection of line-of-responses.

Limited-Angle Tomography—Conventional tomography requires 360° coverage with PET detectors. The “time-of-flight” information relaxes this condition and allows formation of artifact-free and accurate images from a limited number of detectors covering less than 360°. This is known as “limited-angle tomography,” or LAT. TOF information restricts the point of positron emission to a segment of the line-of-response only. Surti & Karp [6] investigated the performance of a limited-angle TOF-capable, breast scanner to determine whether it was possible to achieve artifact-free tomographic images for studies focused on detection and quantification of lesions in the breast. Their simulation was based on an EGS4 package and showed that without TOF information, the limited-angle scan led to distortions and severe artifacts in the reconstructed image. By using TOF information, many of the distortions and non-uniform artifacts were reduced. However, as the angular coverage was reduced, better timing resolution was needed to produce artifact-free images.

### SUMMARY

A moveable PET scanner suitable for use interoperatively in a surgical suite or at a patient's bed side is disclosed. It comprises multiple scintillator/SSPM modules positioned along the length of upper and lower arms of a mobile device. The lower arm is configured to be placed directly below and adjacent a patient prone on an operating table by insertion in a space normally existing or formed just under the patient support surface.

### BRIEF DESCRIPTION OF FIGURES

FIG. 1 is a schematic representation of two annihilation photons.

FIG. 2 is a schematic representation of showing two arrays of multi-pixel photon counters arranged to read the light emitted from first and second ends two ends of a scintillator module.

FIGS. 3a and 3b are schematic representation of the side and bottom view, respectively, of an array of multi-pixel photon counters connected to an output end of stacked scintillators.

FIG. 4 is an example of a display from a one-layer array of scintillators and a multiple SSPM block.

FIG. 5 illustrates a gamma ray incident on the top level through of stacked scintillators.

FIG. 6 shows the flood image of the double-layer array of FIGS. 3 and 5.

FIG. 7 shows a schematic representation of an array of two types of scintillators with different decay times stacked, one type in one layer on top of the second type, and SiPMs attached to the exposed end of one of the layers.

FIGS. 8a and 8b schematically illustrate scintillation lights that enter the SiPM from a gamma ray interaction far from the SiPM (FIG. 8a), and near to the SiPM (FIG. 8b).

FIG. 9 shows one embodiment of a PET scanner incorporating features of the invention. Blocks of scintillator-SiPM arrays are attached to a set of movable slabs that surround the patient. In this configuration the lower set of detector blocks is flat.

FIGS. 10 and 11 are two representative examples of a surgical platform with a space below the patient support surface for insertion of the lower array of the mobile PET scanner described herein.

FIGS. 12a, 12b and 12c are schematic representation of a PET scanner module placement for (a) a full set of detectors covering 360 degrees, (b) ⅔ of full set of detectors (a limited angle of 120 degrees in-plane coverage), and (c) ½ ring (90 degrees in-plane coverage) PET scanner detector configuration.

FIG. 13 is a schematic representation of a parallel embodiment of a portable PET unit with two set of detector blocks incorporating features of the invention.

FIG. 14 is a schematic representation of a parallel embodiment of a portable PET unit also having one or more side detector blocks incorporating features of the invention.

FIG. 15 is a schematic representation of a prior art mobile CT scanner unit.

FIG. 16 is a schematic representation of a laser pointer.

FIG. 17 is a schematic representation of the laser pointer of FIG. 16 mounted on a mobile PET scanner incorporating features of the invention.

FIG. 18 is a schematic representation of the PET scanner with tracking device and laser pointer marking a tumor site and displaying an interoperative PET scan with the tumor shown thereon.

FIG. 19 is a schematic representation of a reconstructed image of a calibration phantom.

FIG. 20 is a schematic representation of a Na-22 beta-annihilation photon attenuation correction imaging line source.

FIG. 21 is a schematic representation of the placement and scan direction of the attenuation correction imaging line source

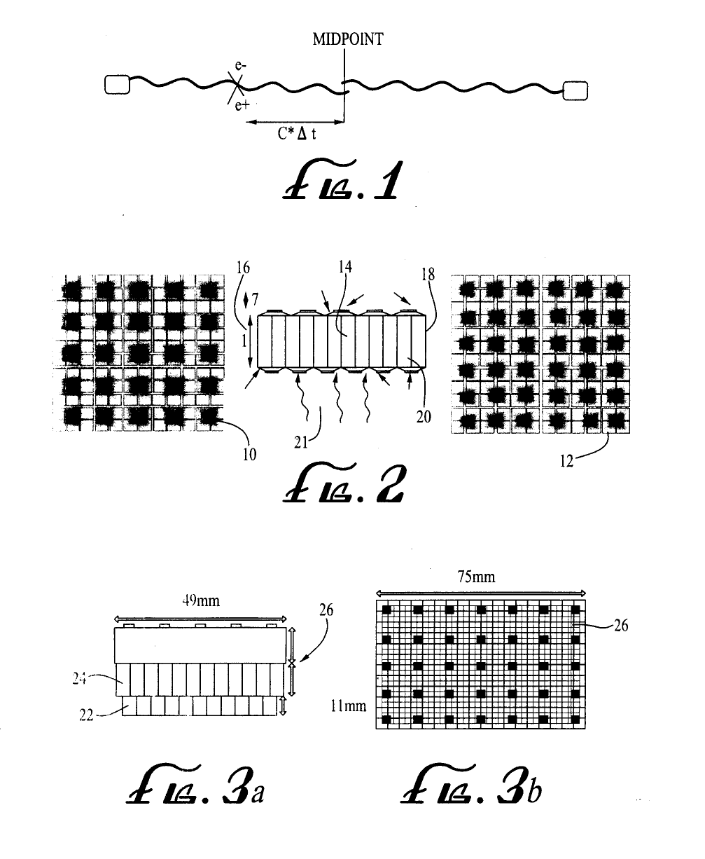

### DETAILED DISCUSSION

The current practice of tumor surgery or biopsy relies on visual observation, palpation, and pre-operative PET/CT, CT, or MRI. In cases where the patient has had previous surgery or radiotherapy, anatomical changes and the presence of scar tissue make visual observation and palpation difficult for locating hyper-metabolic foci. The application of real-time Spot-PET during surgery will mean tumors will be located more accurately and quickly. In addition, the use of Spot-PET will present unique opportunities for applying PET-guided intuitive tools, in pinpointing tumor locations.

The X-ray C-Arm and intra-operative ultrasound brought the power of x-ray and ultrasound imaging into the operating room. These diagnostic tools made many surgical procedures possible and simplified others. A further improvement is provided by the Spot-PET scanner and its associated surgical guidance systems which includes, but is not limited to, the devices and systems described below: A. A portable PET is a novel instrument set forth in applicants U.S. Pat. No. 7,750,311 issued Jul. 6, 2010, incorporated herein in its entirety by reference: B. The idea of “time-of-flight assisted limited-angle tomography” was first proposed by Surti and Karp for positron emission mammography [6]. Our intra-operative application of this theoretical concept is novel. The devices and concepts set forth in a University of Pennsylvania U.S. Utility application Ser. No. ______ filled Nov. 3, 2009 (not yet published) incorporated herein in its entirety by reference; C. The new system described herein, which uses a low-cost “fast-limiting amplifier” for sub-nanosecond timing of “solid state photomultiplier,” which makes the implementation of time-of-flight information economical; D. Use of the Ca co-doped LSO scintillator, which has 30% faster and 30% higher light than regular LSO [7]; E. The surgical guidance tools disclosed herein, particularly when used in combination with the Portable Spot-PET device set forth in A above.

### Detector Modules Capable of Depth of Interaction Estimation:

DOI Determination Based on the Ratio of Scintillation Light—In this embodiment, shown in FIG. 2, two arrays of MPPCs 10, 12 (MPPCs (multi-pixel photon counters) are a form of a Silicon Photomultiplier) read the two ends of a module 20 of LYSO (Lutetium-Yttrium OxyorthoSilicate) scintillation crystals 14 as shown in Each LYSO is 16 mm long and has a 4×4 mm base. The depth of interaction of impinging gamma rays 21 (arrows in FIG. 2) along its length is determined by the comparison of the light intensities on the first and second sides or ends 16, 18. Twenty-five MPPCs are on the first end 16 and 36 MPPCs are on the second end 18 of this 12×12 array of LYSO scintillators. MPPCs have a 3×3 sensitive area, and the LYSOs are 4×4×16 mm. Each module 20 has 12×12=144 pieces of LYSO crystals. An array of 6×6=36 MPPCs at the bottom (closer to the source of radiation) reads the module. Semi-pyramid light guides (not shown) spread the light of the scintillators and guide them into the MPPCs. On the top side or end 18 of the scintillators the other array of 25 MPPC is coupled via 25 semi-pyramid light guides (not shown).

The crystal of interaction is identified by the ratios of the MPPCs in the 25-array (top, T) as well as the MPPCs of the 36-array (bottom, B). The depth of interaction is determined by the sum signal of both arrays.

$$DOI = 16 mm * ( 1 - \frac{Σ Ti - Σ Bi}{Σ Ti + Σ Bi} )$$

From the top MPPC array we can find the X and Y:

$$X top = \frac{Σ xiTi}{Σ Ti} ; Y top = \frac{Σ yiTi}{Σ Ti}$$

And from the bottom MPPC array:

$$X bottom = \frac{Σ xiBi}{Σ Bi} ; Y bottom = \frac{Σ yiBi}{Σ Bi}$$

By averaging them one can find the x and y position of the point of interaction of the annihilation photon:

Xave=0.5*(Xtop+Xbottom); Yave=0.5*(Ytop+Ybottom)

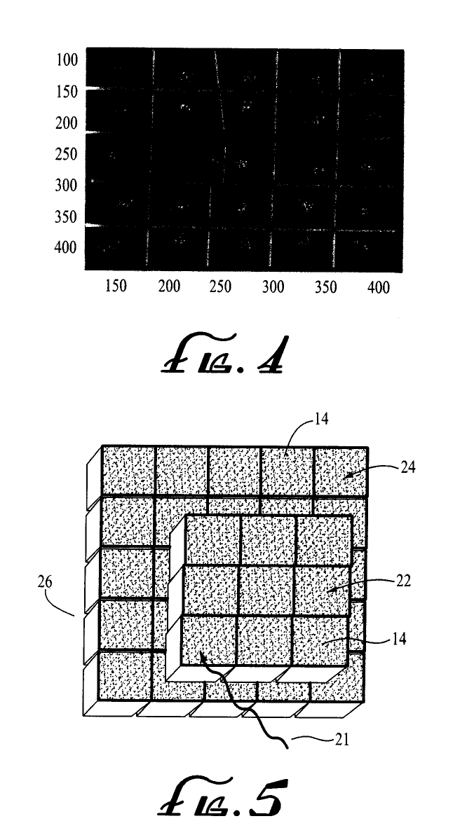

Staggered multi-layer Module 26—In this design, two LYSO arrays 22, 24 are positioned, one atop the other, as shown in FIG. 3; the first layer of LYSO 22, which will be positioned closer to a patient, consists of 6 mm-long LYSOs (the shorter crystals). The second array of LYSO 24 are 10 mm long (the longer crystals). The scintillation light of each of the shorter LYSOs 22 are divided so it transfers into the four LYSOs of the second layer 24 that are positioned adjacent and are preferably glued to it. Thus, two layers of scintillators are piled on top of each other in a staggered manner. A light guide of fused silica then connects them to an array of MPPCs.

Since the majority of gamma rays that enter at a large angle will interact in the shorter LYSO 22, and these large angle gamma rays cause most of the depth-of-interaction problem, it can then be assumed that most of the DOI problem will be alleviated by this design (FIG. 3). Referring to FIG. 3, if the second array of long LYSO crystals 24 exists alone, the average x position of the light will be <x1> or <x₃>, and the area between <x₁> and <x₃> will be dark. With the array of short LYSOs 22 placed on top of the first array with an offset position in x and y, then gamma ray interactions with crystal of this short layer will show an average x position of light with a value in between <x₁> and <x₃>. The same logic would apply to the y-axis as well. A look-up table would be able to identify which crystal of which array (deep or shallow) captured the gamma ray.

An example of a display from a one-layer array of scintillators and a multiple SSPM block is shown in FIG. 4. In this example a 5×5 array of LYSO scintillators 24, each 4×4×10 mm, is connected to a clear plastic slab (BC-800 Saint Gobain) with the thickess of 3.25 mm and size of 25×25 mm, using optical gel. A 5×5 array of SSPM (S10931-050P, Hamamatsu) is attached on the other side of this light guide. The SSPMs have a 3×3 mm sensitive area. LYSO scintillators were wrapped with Teflon and placed next to each other. A 2-D resistor chain connected these SSPMs and resulted in four output signals. These signals were then amplified and digitized (Datel PCI-416).

Positioning was obtained by applying the following formula:

$$X = \frac{{\sum }_{i} {x}_{i} {E}_{i}}{{\sum }_{i} {E}_{i}} Y = \frac{{\sum }_{i} {y}_{i} {E}_{i}}{{\sum }_{i} {E}_{i}}$$

Where Eᵢ is the amplitude of the signal from the i^{th} MPPC. 2 microCi of F-18 were placed 5 cm away from the arry and data was acquired for 1 min. FIG. 4 shows this flood image, with each scintillator clearly differentiated.

### Double Layer, Staggered Scintillator Array

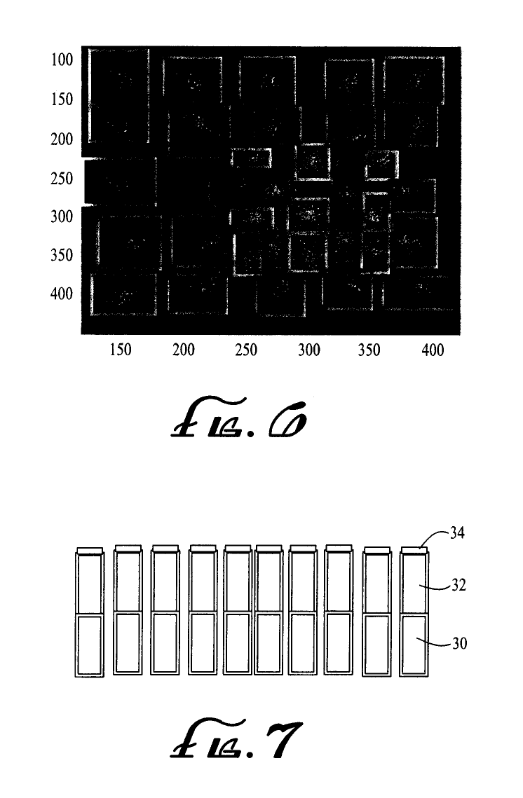

FIG. 5 shows a schematic arrangement of a scintillator array (9 LYSOs each 4×4×6 mm) placed over that of the above embodiment with an offset of 2 mm in x and y directions. The top layer is staggered, providing depth of interaction information. A gamma ray has deposited its energy in a top-level scintillator and this light is transferred to the array of SSPMs. Optical gel connect these two arrays (FIG. 5). The staggered placement of the second level array causes the scintillation light of each upper LYSO to divide to four LYSOs of the first level and then reach the SSPMs via the light guide. The centroid of these events registers between the centroids of the crystals of the first level. FIG. 5 illustates a gamma ray incident on a first level of stacked scintillators 22. The scintillation light generated propagates through the scintillators 24 of the second level. Here the gamma ray is absorbed in one of the top level scintillators. FIG. 6 shows the flood image of the double-layer array. A comparison with FIG. 3 easily identifies the scintillators of the second levels from those of the first level. A template is shown that can be used to assign events to the correct scintillator.

### DOI Determination Based on the Decay Time Difference of Two Types of Scintillators

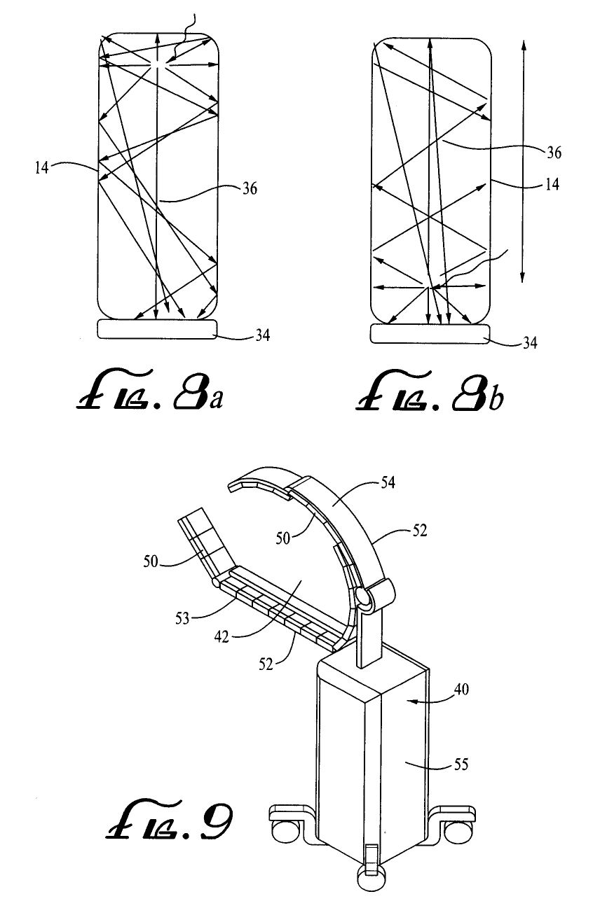

In this embodiment two types of scintillators 30, 32 that have different decay times are used with one type in one layer on top of the second type. SiPMs 34 are attached to one of the layers (FIG. 7). Two sub-methods can be used
1—In the phoswitch method two amplifiers are used decay times are calculated for the waveforms. Using a waveform digitizer, the scintillation pulse can be captured from the detector. It is then simple to fit a known shape to the waveform and calculate the decay time of the pulse. By mapping the decay time of the pulse to the layer of the crystal, the depth can be inferred.
2—In the time of arrival of the first photon method the fast scintillator would have an earlier time of arrival and this would work as a differentiator of the layer of the interaction.

FIG. 8a shows a scintillator 14 with scintillation lights 36 that are generated near the SiPM 34 enter it without many reflections from the scintillator 14 walls; FIG. 8b illustrates scintillation lights that are generated far from the SiPM 10 and enter it after many reflections from the walls of the scintillator 14. One can see that if the gamma ray interacts near the SiPM, then the percentage of un-reflected light is higher than when the gamma ray interacted far from the SiPM. The time of arrival of scintillation light to the SiPM has different distributions depending the depth of gamma ray's point of interaction. Therefore by using a long and narrow scintillator coupled to one SiPM, and measuring the time distribution of the scintillation lights, one can estimate the depth of interaction. The time distribution of the scintillation pulse can be measured by using a fast digitizing ADC converter on the output signal of the SiPM device. Digital algorithms on the shape of the pulse can be used to lookup the depth of interaction.

### OPEN-PET

### First Embodiment

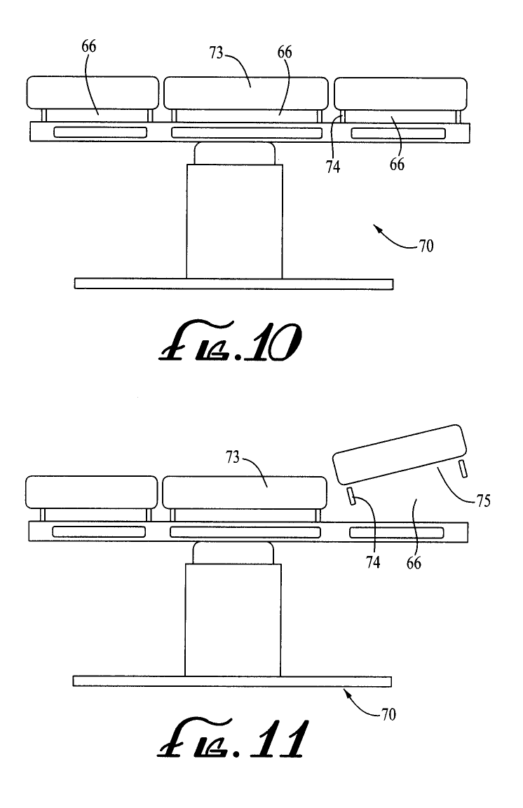

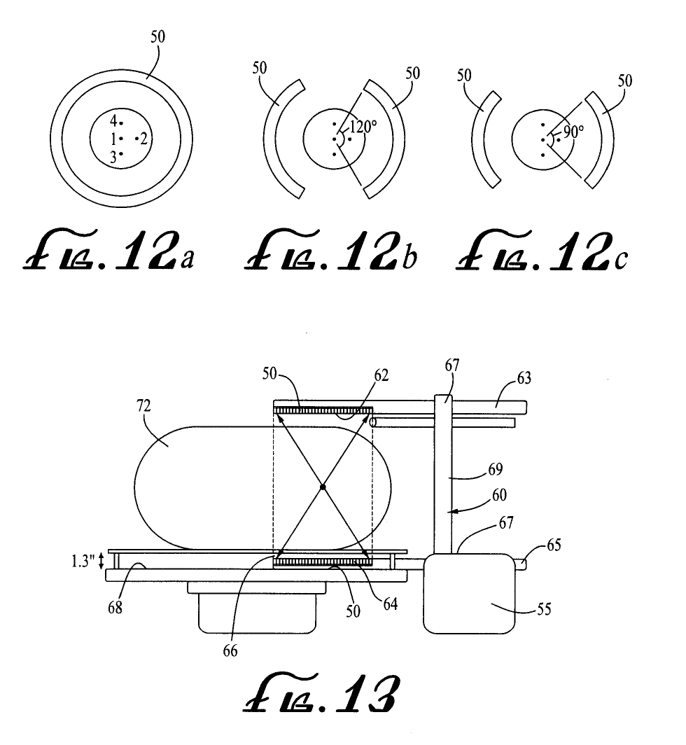

FIG. 9 shows one embodiment of a mobile PET scanner 40 incorporating features of the invention. The detector blocks 50 in the embodiment shown are 8 cm long, and 1.6 cm thick. The frame 52 that supports the blocks are stainless steel 3 mm thick. The upper portion 54 slides to open and close the patient enclosing space 42 defined by the surrounding detector blocks 50. The cart is designed as a mobile PET unit and is adjustable so that the bottom frame 53 with detector blocks 50 of the PET unit can be fit through a gap or space 66 below a patient 72 placed on an operating table 70, such as shown by the arrow 56 in FIGS. 10 and 11.

### Placement of the Detector Inside the Gap in the Operating Room Table

All clinical PET scanners are based on the use of photomultiplier tubes, which are relatively large (several centimeters). Because Solid-State Photo-Multipliers (SSPM) have dimensions of only a few millimeters, it is now possible to build a PET scanner with detectors that can fit in the gap that exists between the operating table 70 and the mattress 73 under a patient 72 on the operating table (FIGS. 10 and 11). Substantially all brands of operating room tables 70 have this gap 66. In addition, some are built by placing the mattress 73 on a removable platform, and the gap is maintained by mounting the platform on the table via four short legs 74 such as shown in FIG. 11. The platform 75 is made of materials transparent to radiation and the gap 66 between this platform and the table is typically about 4 cm. While these gaps 66 are provided for placement of a cartridge for intra-operative x-ray imaging they are particularly suitable for receiving the array of detector blocks 50 incorporated in the portable PET device 40 described herein. This is preferable to placing the lower detectors under the table where many other objects such as wires, tubes, tables legs etc that would interfere. Placing the lower detectors in the gap minimizes the distance to the patient for the lower PET detectors and therefore maximizes the sensitivity and reduce the amount of the detector material needed.

Time-of-Flight (TOF) Information—Photons travel 300,000 km per second, or 30 cm per one nanosecond. With the advent of faster photodetectors and faster scintillators, it has become possible to estimate the position of the positron annihilation by measuring the time difference of arrival of the two annihilation photons into the detector. Presently the time resolution of the PET detectors is more than 300 nanosecond (or 10 cm travel of a photon), therefore this information lacks sufficient resolution to locate the distribution of radioactivity using the Time-of-Flight (TOF). However this TOF information can help improve tomographic image reconstruction from the collection of line-of-responses.

Limited-Angle Tomography—It is also possible to form tomographic images from detectors not forming a complete circle utilizing a limited set of angles. This is possible only if appropriate “additional” information is available. This is known as the “limited-angle tomography”. For example, S Surti & J S Karp have investigated the performance of a limited-angle, but TOF-capable, breast scanner to determine whether it is possible to achieve artifact-free tomographic images for studies focused on detection and quantification of lesion in the breast. They performed Monte Carlo simulations for a breast scanner design in order to understand the benefit of TOF in reconstruction of limited angle PET data. The Monte Carlo simulation is based on an EGS4 simulations package which models annihilation photon emission and transmission (with attenuation and scatter) through a geometric phantom, tracks their subsequent passage through a scintillation detector configuration, models the detector light response and point spread function as well as timing resolution, and outputs a list-mode data set where each event is tagged as scattered (in the phantom) or true (unscattered) event (Adam and Watson, 1999, Surti et al., 2004, Surti et al., 2006). In this work they reconstructed only the true coincidences. The simulated scanner had a ring diameter of 15-cm and axial length of about 15-cm.

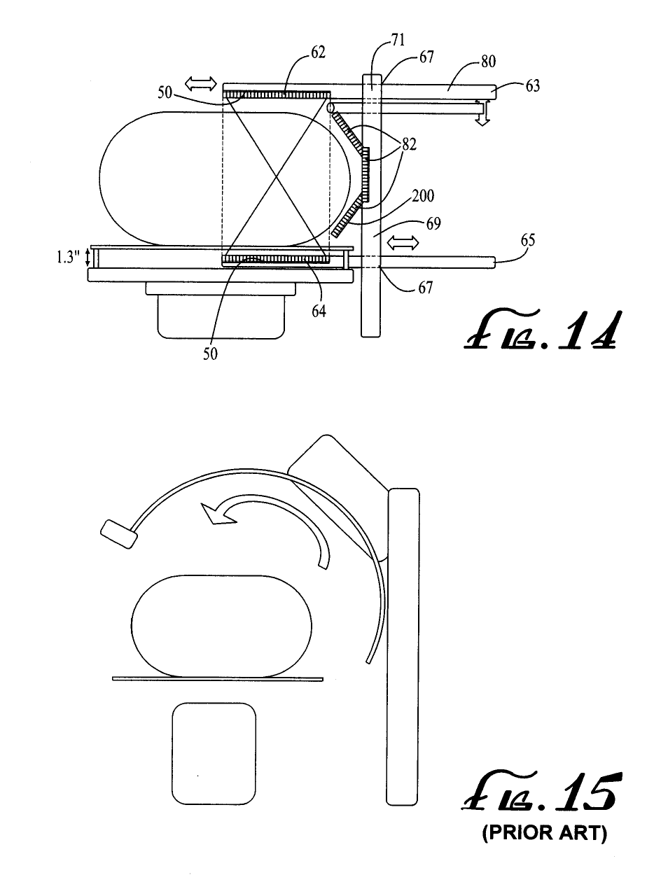

Three different LSO crystal sizes were simulated for the detector: 1×1×10-mm³, 2×2×10-mm³, and 3×3×10-mm³. The simulated phantoms had a 10-cm diameter with an 8-cm cylinder length or a 6-cm diameter with a 8-cm cylinder length, each containing three 5-mm diameter hot spheres with 8:1 uptake with respect to background (at {x,y} coordinates of {0,0}, {3,0}, and {0,−3) cm in the 10-cm diameter cylinder and at {x,y} coordinates of {0,0}, {1.8,0}, and {0,−1.8) cm in the 6-cm diameter cylinder), and one cold sphere (at {x,y} coordinates of {0,3} cm in the 10-cm diameter cylinder and at {x,y} coordinates of {0,1.8} in the 6-cm diameter cylinder). The scan times were calculated by assuming a 15-mCi 18F-FDG injection followed by a 1 hour uptake period leading to an 18F-FDG concentration of 0.0975-μCi/cc in the breast (representative of the average radiotracer concentration in normal breast tissue (Zasadny and Wahl, 1993)). Image reconstruction was first performed using data from a full scanner ring (complete 180 degree in-plane angular coverage). For partial ring geometries, data from the full scanner ring simulation were gated to throw away those events not lying within the angular coverage region. In this way image reconstruction was also performed for a two-third scanner ring (120 degree in-plane angular coverage) and a half scanner ring (90 degree in-plane angular coverage) (FIG. 12a-c). FIGS. 12a, 12b and 12c show the scanner setup for the (a) full, (b) ⅔ (120 degrees in-plane coverage), and (c) ½ ring (90 degrees in-plane coverage) scanners. The ring diameter and the axial length for the scanners are 15-cm. The simulated cylindrical phantom (length is 8-cm, diameter is 6 or 10-cm) has three, 5-mm diameter hot spheres (lesion 1, 2, and 3) with 8:1 uptake with respect to background, and one, 5-mm diameter cold sphere. The scanner ring diameter was fixed at 15-cm.

For image reconstruction they used a 3D list-mode iterative reconstruction algorithm using chronologically ordered sub-sets. This algorithm uses a Gaussian TOF kernel for TOF reconstructions. Using a relaxed OSEM update equation (i.e., λ=1) with 33 subsets, they found that they can use 3-6 iterations of the reconstruction algorithm, depending upon the timing resolution, to achieve maximum contrast for the hot lesions. The voxel size of the reconstructed images was 0.5×0.5×0.5-mm3. For quantitative analysis they used a contrast recovery coefficient (CRC) metric to estimate the sphere uptake accuracy for the hot spheres. For this calculation, regions-of-interest (ROIs) were drawn over the hot and cold spheres, equal in size to the sphere diameters, to obtain the mean counts (CH for the hot, and CC for the cold lesion). Annular regions beyond the sphere diameter of 5-mm were drawn to estimate the background counts (CB) (inner diameter of 10-mm and outer diameter of 20-mm). The background ROIs were drawn locally in this manner due to the non-uniformities and artifacts which arise in some of the reconstructed images that will lead to incorrect estimation of the background counts. CRC for hot spheres was calculated using the NEMA definition (2001):

$$CRC = \frac{\frac{{C}_{H}}{{C}_{B}} - 1}{8 - 1}$$

Similarly for the cold sphere, CRC was estimated by:

$$CRC = 1 - \frac{{C}_{C}}{{C}_{B}}$$

In addition, we also calculated a simple measure of signal-to-noise (SNR) given by:

$$SNR = \frac{\frac{{C}_{H}}{{C}_{B}} - 1}{\sqrt{{( \frac{{σ}_{H}}{{C}_{H}} )}^{2} + {( \frac{{σ}_{B}}{{C}_{B}} )}^{2}}}$$

where σH is the standard deviation of counts in an ROI drawn over the lesion, and σB is the standard deviation of counts in the background ROI.

Using this simulation, Surti and Karp show that without TOF information, the limited angle situation leads to not only distortions, but also severe artifacts in the reconstructed image as the object size relative to the scanner ring diameter increases. The reconstructed image in this situation for a warm cylinder with hot/cold lesions has large non-uniformities in the background. This greatly limits the use of such a PET scanner in quantitative imaging situations, especially those where the scanner ring diameter is small in order to achieve high geometric sensitivity. Consequently, detector rotation needs to be employed to cover all the missing LORs, which however leads to longer scan times or essentially a reduction in effective sensitivity.

Applicant has now found that by using TOF information, a lot of the distortions as well as non-uniform artifacts can be reduced without the need for detector rotation. However, as the angular coverage is reduced, better timing resolution is needed to produce artifact-free images. In particular, applicant has found that a timing resolution of 600 ps or better was needed for a ⅔ ring scanner (scanner ring diameter of 15-cm), while a timing resolution of 300 ps or better was necessary for the ½ ring scanner geometry, in order to achieve hot lesion CRC values similar to a full ring scanner. This suggests that there is a trade-off in the design of such PET scanners where the timing resolution will be determined by detector performance which, in turn, will define the minimum angular coverage needed in the scanner for artifact or distortion-free images without rotation. While this study uses a symmetric gap distribution between the two detectors, it may be possible to achieve artifact-free images with TOF PET in situations where there are more than two gaps or gaps of unequal size as well.

Surti and Karp conclude that TOF PET imaging can have an important application in the design of limited angle, application specific PET scanners. By producing distortion-free and artifact-free images one can avoid the need for detector rotation in order to achieve quantitative, tomographic images. This can have an impact in the design of not only dedicated breast scanners, but also in-beam PET scanners for monitoring of dose delivery in proton and heavy ion therapy machines. However, Surti and Karp fail to teach the use of this method on a region of the body, in the abdomen or torso in the operating room for the purpose of finding a tumor and a repeat imaging subsequent to tumor removal to check for its completeness.

### Spot-PET

### Second Embodiment

A “spot-PET scanner” is proposed to provide PET images of a portion of the body in the operating room. These further embodiments of the detector design for a PET scanner for spot imaging, are based on fast SiPM or Digital Photon Counter—DPC, and the Ca-dopped LSO scintillator that enable “time-of-flight assisted limited-angle tomography”. The theory of the “time-of-flight assisted limited-angle tomography” was simulated for a dedicated breast imaging system (ref. Karp et al. 2009).

We performed simulations to determine if a time-of-flight assisted, limited-angle tomography Spot-PET could obtain images of a torso-sized object that were comparable to those generated by commercial PET scanners. Simulations were performed with GRAY (P. Olcott, S. Buss, C. Levin, G. Pratx, and C. Sramek, “GRAY: High Energy Photon Ray Tracer for PET Applications,” Nuclear Science Symposium Conference Record, 2006. IEEE, vol. 4, 2006, pp. 2011-2015), an in house fast Monte Carlo package for simulating PET. Reconstructions were done with a list mode TOF, 3D, GPU OSEM reconstruction algorithm (G. Pratx, G. Chinn, P. D. Olcott, and C. S. Levin, “Fast, accurate and shift-varying line projections for iterative reconstruction using the GPU,” IEEE Trans Med Imaging, vol. 28, March 2009, pp. 435-445). ToF information improves the image quality for a limited angle ToF capable intra-operative PET scanner using realistic patient geometries, size and the activity of the hot-spots.

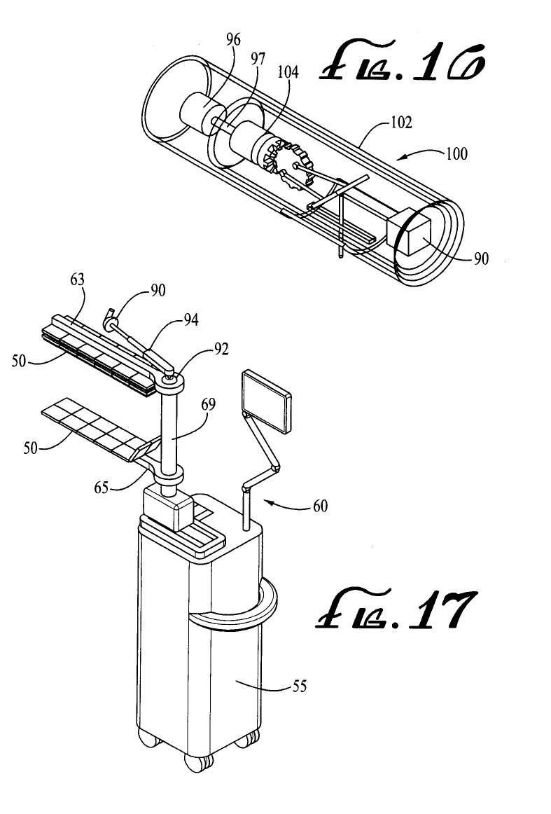

FIGS. 13 and 14 show two embodiments or such a system incorporating features of the invention. In the parallel embodiment shown in FIG. 13 the portable PET unit 60 is shown in a position in which it would be used in an operating room or in a patient's hospital room. The portable PET unit 60 has two substantially parallel (an upper and a lower) arrays 62, 64 of detector blocks 50 with the lower array 62 located in a space 66 just below the top 68 of the operating table or patient bed 70. The upper array 62 is space from the lower array 64 with the patient 72 located between the parallel arrays 62, 64.

In the 270° embodiment 200 of FIG. 14 shows a second embodiment of a portable PET unit 80 having the upper and lower array 62, 64 but also having one or more side arrays 82 to capture photons emanating sideways.

Using the digital photon counter (DPC) or fast SiPM that has timing resolution of better than 200 ps FWHM, and the Ca-doped LSO which is a faster scintillator than LSO, time-of-flight assisted limited angle tomography can now be used.

The PET detector arms 63, 65, each generally about 70 cm long, will each carry a load of 16 kg (12×0.35=4.2 kg lead+128×12×0.007=11 kg LSO). The outer- and inner-most blocks 50 have mechanical risers (not shown) to allow for adjustment of the blocks. These provide the ability to tilt the blocks 50 up to 60° degrees toward the patient to narrow the field of view and enhance the scan. The collar 67 of each PET detector arm 63, 65 slides up and down preferably about 7 cm along a motorized track on the central shaft 69. The top arm 63 also has a rotation collar 71 allowing it to rotate 180° when not in use for imaging, allowing the arm to be moved so it does not interfere with the surgical staff working on the patient. The wheeled base cabinet 55 stores the electronic boards, computer, the surge protector, motors for manipulating the system components and other auxiliary equipment useful in operating the portable PET unit. A motorized slide (not shown) is mounted on or in the base cabinet 55 to support the central shaft 69 and arms; this will allow axial travel, usually about 10 cm, of the PET scanner arms as well as ±10 cm transaxial movement.

Hybrid Imaging with X-ray CT:

Positron emission tomography lacks the precise anatomic information. This information can be provided by simultaneous use of x-ray CT. For this reason many imaging centers use a hybrid PET-CT unit. These machines contain a PET detector ring, as well as the rotating x-ray generator and detectors of the CT scanner in one large housing. However, these are large stationary pieces of equipment. A movable table is used to move the patient step by step through both the combined systems. The price of each PET-CT machine is around $2 Millions. No portable combined units exist or are currently feasible in the absence of the applicant's teachings herein.

Intra-Operative x-ray CT: Presently there is only one company (Medtronic Corp, Minnesota) that manufactures a mobile x-ray CT unit, the O-ARM® Imaging System, which is a fully portable CT scanner. This scanner can be placed next to any of the embodiments of the portable PET scanner disclosed herein and they can be positioned in a coaxial formation. A laser light beam and position-sensing light detector (not shown) can be used to ensure the alignment of these two scanners. The central planes of both the portable PET and the CT scanner are positioned as close as possible but at a pre-determined distance apart. This distance is then used to co-register the images of the intra-operative PET with the intra-operative CT. Recently a research group has attempted to use a x-ray C-arm for performance of x-ray tomography (Multi-Mode C-Arm Fluoroscopy, Tomosynthesis, and Cone-Beam CT for Image-Guided Interventions: From Proof of Principle to Patient Protocols, J. H. Siewerdsen, M. J. Daly, G. Bachar, D. J. Moseley, G. Bootsma, K. K. Brock, S. Ansell, G. A. Wilson, S. Chhabra, D. A. Jaffray and J. C. Irish; Medical Imaging 2007: Physics of Medical Imaging, edited by Jiang Hsieh, Michael J. Flynn, Proc. of SPIE Vol. 6510, 65101A, (2007) Proc. of Medical Solutions for 3D imaging (FIG. 15) Based upon a Siemens PowerMobil, the device includes: a flat-panel detector (Varian PaxScan 4030CB); a motorized orbit, a system for geometric calibration, integration with real-time tracking and navigation (NDI Polaris) and a computer control system for multi-mode fluoroscopy, tomosynthesis, and cone-beam CT. Investigation of 3D imaging performance (noise-equivalent quanta), image quality (human observer studies) and image artifacts (scatter, truncation, and cone-beam artifacts) has led to the development of imaging techniques appropriate to a host of image-guided interventions. Multi-mode functionality presents a valuable spectrum of acquisition techniques: i.) fluoroscopy for real-time 2D guidance; ii.) limited-angle tomosynthesis for fast 3D imaging (e.g., ˜10 sec acquisition of coronal slices containing the surgical target); and iii.) fully 3D cone-beam CT (e.g., ˜30-60 sec acquisition providing bony and soft-tissue visualization across the field of view). Phantom and cadaver studies clearly indicate the potential for improved surgical performance—up to a factor of 2 increase in challenging surgical target excisions. The C-arm system is currently being deployed in patient protocols ranging from brachytherapy to chest, breast, spine, and head and neck surgery.

As a second operating modality, the Spot-PET described above can be moved around the patient before or after the patient was scanned by a portable x-ray CT scanner. The two scans, (PET and x-ray CT) can then be fused together by using markers placed on the patient to provide positional information. The CT can be used for attenuation correction as well as anatomic and functional fusion.

### Surgical Guidance Systems:

One advantage of real-time Spot-PET versus pre-operative PET scans is that the coordinates of the PET images are easily projected onto the patient coordinates. Conversely, pre-operative images taken at different settings are almost impossible to correlate with the patient on the surgical table. Three novel methods are given as examples of guidance systems that can be used to facilitate the localization of tumors.

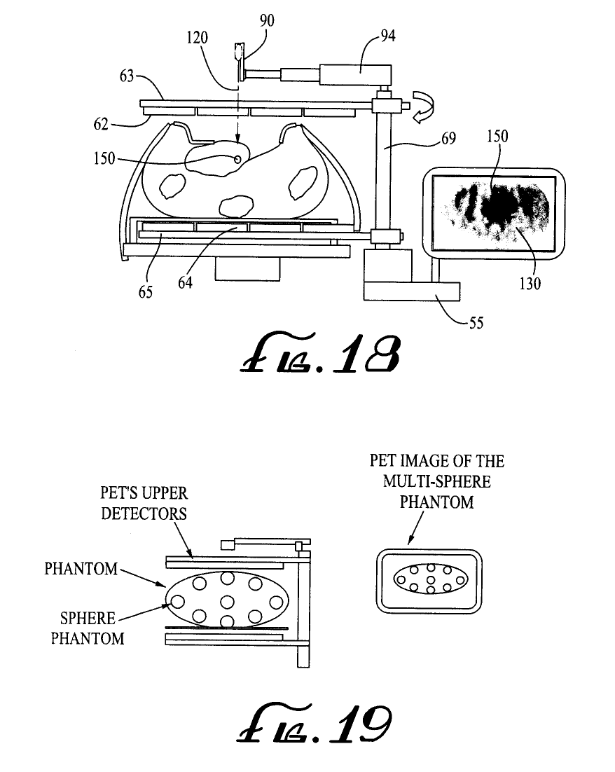

Computer-Controlled Laser Pointer—Pointing Location of “Hot Spot”—To intuitively guide the surgeon to the location of a hyper-metabolic foci, a laser pointer is mounted above the surgical field in open surgery. The laser pointer 90 such as shown in FIGS. 16 and 17 fixed to a telescopic arm 94 is in communication with, is mounted on and is position controlled using a computer-controlled pan and tilt positioner. This arm can also be rotated around an axis fixed on the Spot-PET scanner (FIG. 17). The telescoping laser pointer 90 such as shown in FIG. 16, is mounted, such as shown in FIG. 17, above the upper PET scanner arm 62 on a pivot 92 at the top of the central shaft 69 for rotation up to 360°. The pivot 92 allows the laser pointer 90 to be rotated independent of the PET scanner arms 63, 65. The system can also include a pivot motor (not shown) with a counterweight to aid in smooth positioning. A telescoping extension arm 94 with length of from about 15 to 45 cm allows the laser or light pointer 90 to extend to the end of the PET scanner arms 63, 65. The 360° tilt and rotation pivot 92 for the laser pointer 90 allows it to point to almost any location on the operating field. Computer-controlled motors move the laser pointer 90 and encoders track the position of the laser pointer 90. It is contemplated that surgical guidance mechanism with laser pointer explained herein is not limited to use on The PET scanner described herein but can be applied to various other intra-operative CT scanners, C-Arm x-ray scanners, MRI scanners and the like to assist the surgeon in locating tissue or organs for surgical procedures.

Surgical Guidance Systems:—One advantage of real-time Spot-PET versus pre-operative PET scans is that the coordinates of the PET images are easily projected onto the patient coordinates. Conversely, pre-operative images taken at different settings are almost impossible to correlate with the patient on the surgical table. Three novel methods are presented to facilitate the localization of tumors.

Correlation of the Spot-PET to the Patient's Coordinates: By imaging a phantom made of multiple hot spheres we find a linear transformation, T, between the points in the PET scan, [Pijk], and the points on the operating table, R(x,y,z):

R(x,y,z)=T[Pijk].

The coordinates of the centers of the spheres, R(x,y,z), are then used for finding T.

The surgeon scans the patient and then uses a sterile joystick to mark the center of the tumor on the image. The computer then applies the coordinate transformation operator, T, that was found after calibration, to find the corresponding center of the tumor. The tilt and span positioner automatically moves the laser 90 above the tumor's center, which may be deep inside the body. In addition, the surgeon can also use the PET image to determine the depth that the tumor is located below the surface of the operating field of the tumor. The surgeon can also determine the distance between the laser's point on the surface and the tumor's center using the PET image and the transformation T. This depth information can further provide guidance to the surgeon.

A laser pointer 90 such as shown in FIG. 16 can also be used in laparoscopic, thoracoscopic, endoscopic, coloscopic, transvaginal, and other minimally invasive procedures to designate points of interest inside the body. A handle of the device or a set of position trackers (optical or electromagnetic—not shown) houses the position tracker, which the system uses to determine the exact position, orientation and direction of the tracking laser head. The pointer assembly 100 houses a primary rotation motor 96 which turns a rotatable assembly to rotate the laser beam around the shaft 97 up to 120 degrees. Inside the pointer assembly 100, the small laser 90 (available from snakecreeklasers.com) generates a beam which shines on a tilting mirror 102. A small motor 104 provides fine control of the mirror 102 to which the laser is pointed. The laser beam 120 is projected from the mirror 102; the primary rotation motor 96 controls the laser position around a central shaft while the mirror 102 controls laser position along the shaft. By controlling the motors, any spot past the distal end of the assembly can be illuminated by the tracking laser. FIG. 18 illustrates the above described procedure in a surgical environment for pin pointing the tumor within an organ. The laser beam 120 illuminates a spot on the exposed organ while the location (depth) of the tumor 150 from the organ surface is shown on an image 130 generated by the PET scan. The exact depth of the tumor, for example in millimeters from the illuminated spot on the organ, is also displayed on the image so that the surgeon can make an incision to remove the tumor or insert a biopsy tool to obtain a sample of tumor tissue.

Use of Radioactive Markers—Various locations in the body can be tagged by placing a radioactive marker on it during PET scanning. To do so, a sterilized tube with F-18 FDG can be placed as a marker on specific regions. These markers will appear on the Spot-PET scan and help the surgeon to correlate the features of the PET image with various tissues during surgery.

PET-Guided, Position-Tracked Wand—An alternative approach is the use of a position tracker at the tip of a wand or a surgical tool. The computer uses “sonification” to alert the surgeon of the distance to the tumor and the orientation of the wand. Sonification refers to the synthetic generation of sound, with its frequency being proportional to the distance and orientation of tip of the wand or tool, similar to a surgical radiation detection probe. Thus, for any instrument tip, one can simulate the measurement of a radiation detection probe using the acquired Spot-PET image. To do so a position sensor system is used to track the wand with respect to the patient (for example using an electromagnetic device available from Assention Corp).

Image Reconstruction: list-mode real-time 3D ToF GPU-OSEM—The reconstruction package demonstrated in the reference (Pratx, G. Chinn, G. Olcott, P. D. Levin, C. S., Fast, Accurate and Shift-Varying Line Projections for Iterative Reconstruction Using the GPU, IEEE Trans Med Imaging. 2009 March; 28(3):435-45) was modified to accept the list-mode events from the coincidence processor. The reconstruction program provides DICOM compatible images over the network. This reconstruction program outputs images that can be viewed in the operating room substantially instantaneously.

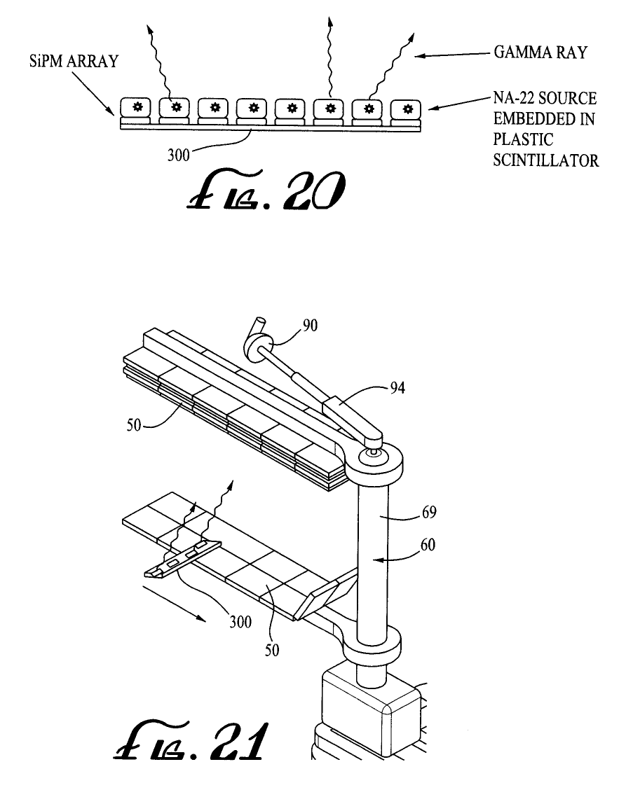

Correlation of the Spot-PET to the Patient's Coordinates: By imaging a phantom made of multiple hot spheres, such as shown in FIG. 19, a linear transformation, T, between the points in the PET scan, [Pijk], and the points on the operating table, R(x,y,z) can be found:

R(x,y,z)=T[Pijk].

The coordinates of the centers of the spheres, R(x,y,z), is then used for finding T.

Attenuation Correction and timing calibration via a Scanning Transmission Source—Attenuation correction is needed for detecting small tumors that are located deep inside the patient. A multi-source plate 300 shown in FIG. 20, comprises Na-22 sources embedded in a plastic scintillator. The positrons of Na 22 generate light in the scintillator that troiggers the SiPM This can be used for timing calibration as well. The multi-source plate is moved on a rail on top of the lower detector plates as shown in FIG. 21. Some of the annihilation photons of Na-22 sources will reach the patient, pass, and strike the upper detector plates. The coincidence between the signals of the SiPM on the source plate and the upper detector plate would uniquely identify these 511 keV photons against those from the patient. The position of the trigging source will be recorded during the transmission scan to uniquely identify the line of responses of the transmission scan. After the transmission scan is finished, the radioactive source will automatically move into a tungsten-shielded compartment in the Spot-PET cabinet. An attenuation map can be acquired in one to two minutes. This can be used for timing calibration as well.

I claim:

1. A mobile PET scanner for use in bed side or a surgical environment comprising:
a mobile support base, said support base having mounted thereon at least a first and a second arm, the first arm configured for placement under a table supporting an individual and a second arm substantially parallel to and above said first arm with the individual being located between the first and second arm,
multiple module blocks positioned along the length of the first and second arm, each modules block comprising at least a first set of scintillators and at least a first set of solid state silicone multipliers or multi-pixel photon counters attached thereto or in optical communication therewith
such that positrons emitted from radiation labeled tissue within the individual's body impinge on the multiple scintillators to generate photons within the scintillators, said photons from each of the scintillator being received by each of a solid state silicone multipliers or multi-pixel photon counters associated therewith, an electrical signal output from each of the solid state silicone multipliers or multi-pixel photon counters caused by said received photons.

2. The mobile PET scanner of claim 1 wherein the electrical signal output from each of the solid state silicone multipliers or multi-pixel photon counters is transmitted to a computerized data collection an analysis system, said a computerized data collection an analysis system substantially instantaneously generating at least a visual image on a screen showing the location within the individuals body from which the positrons are being emitted.
